(19) United States
(12) Patent Application Publication
(10) Pub. No.: US 2025/0387820 A1
(43) Pub. Date: Dec. 25, 2025

(54) PAINTLESS DENT REPAIR GLUE TAB

(71) Applicant: Jonathon Videen, Coon Rapids, MN (US)

(72) Inventor: Jonathon Videen, Coon Rapids, MN (US)

(21) Appl. No.: 18/750,840

(22) Filed: Jun. 21, 2024

(51) Int. Cl. B21D 1/06; B21D 1/12

(52) U.S. Cl. CPC B21D 1/06; B21D 1/12

(57) ABSTRACT

A glue tab for paintless dent repair. The glue tab has a head portion and a dent lifting portion. The glue tab further includes a stem extending between the head and dent lifting portions. The dent lifting portion has an affixment portion with a flat bottom surface. The bottom surface is configured to be affixed to a dent in a vehicle body. The bottom surface further includes a first perimeter extending along an outer edge. A stepped up portion sits between the stem and the affixment portion. The stepped up portion has a second perimeter that substantially follows the first perimeter. The first perimeter is narrower than the second perimeter.

### FIELD OF THE DISCLOSURE

The present disclosure relates to devices for removing surface dents. More specifically, the present disclosure relates to tabs that may be adhered to a dent and pulled upon to remove the dent.

### BACKGROUND

Vehicles, such as automobiles, vessels, aircraft, and the like often have a solid frame surrounded by a thinner body. Such bodies, while generally sturdy and resilient, tend to be deformable. While this makes the bodies suitable for shaping, whether for aerodynamics, hydrodynamics, or aesthetics, this also makes such bodies readily dentable. In particular, such bodies tend to dent upon impact, such as impact with debris, during a collision, or from inclement weather such as hail.

The deformable nature of these bodies makes them suitable to repair by “popping out” or “pulling out” the dents. When particular care is take during this process, dents may be removed or smoothed out without causing any further surface damage. For example, it may be possible to pull out a dent and restore the original shape of a vehicle body without damaging or otherwise requiring painting, which can be time consuming, costly, and prone to leave undesirable visual artifacts, such as when colors used during repair don't exactly match the original, surrounding paint; see, for example, U.S. Patent Publication 20210220889, the contents of which are incorporated herein for all purposes. However, devices and tools currently used to pull out a dent have several drawbacks. In particular, such devices and tools are not well suited to evenly dispersing a pulling force across a dented area. Accordingly, when a dent is pulled out with existing tools, it may result in the outer edges of the dent being pulled out while leaving a depression in the middle of the dent, resembling a volcano shape. If a dent is not pulled out uniformly, it must be pounded back down and the repair process restarted from the beginning. A device that improves the reliability of pulling out a dent on a first attempt would be welcome.

### SUMMARY OF THE INVENTION

A glue tab for paintless dent repair includes a head portion, a dent lifting portion, and a stem. The stem extends between the dent lifting portion and the head portion. The dent lifting portion includes an affixment portion having a flat bottom surface. The flat bottom surface is configured to be affixed to a dent in a vehicle body. A first perimeter extends along an outer edge of the flat bottom surface. A stepped up portion is located between the stem and the affixment portion. The stepped up portion has a second perimeter which substantially follows the first perimeter. The stepped up portion is wider than the affixment portion. In embodiments, the glue tab is a single polymer piece.

In embodiments, the affixment portion has a first thickness and the stepped up portion has a second thickness. The first and second thicknesses may be substantially similar. In embodiments, a difference in width between the first and second margins remains constant around an entirety of the perimeters of the affixment portion and the stepped up portion. In embodiments, the difference in width is between 0.25 and 3.5 mm. In embodiments, the difference in width is about 0.9 mm. In embodiments, a planar cross section of the affixment portion is geometrically similar to a planar cross section of the stepped up portion. In embodiments, the head portion is configured to interface with a pulling tool. In embodiments, the head portion comprises a hexagonal top surface. In embodiments, a first end of the stem is generally centered on the stepped up portion and an opposite end of the stem is generally centered on the head portion.

According to embodiments of the invention, a device for removing dents from a vehicle body includes a first lifting surface, a second lifting surface disposed on top of the first lifting surface, and a gripping portion affixed to the second lifting surface. The first lifting surface is configured for attachment to a vehicle body. The second lifting surface has a margin portion that extends outwardly beyond an outside edge of the first lifting surface. The margin portion is defined by the outside edge of the first lifting surface and an outside edge of the second lifting surface, such that the outside edge of the second lifting surface can flex about the first lifting surface.

In embodiments, the margin portion has a constant width. In embodiments, the constant width is within 10% of a thickness of the first lifting surface. In embodiments, a thickness of the second lifting surface is about the same as the thickness of the first lifting surface.

In embodiments, a neck extends between the second lifting surface and the gripping portion. The neck is narrower than the second lifting surface. In embodiments, the first and second lifting surfaces each define a circular shape. In embodiments, the first and second lifting surfaces each define a shape with three or more sides, where each side has an equal length. In embodiments, the first and second lifting surfaces each define a shape with four or more sides, such that a pair of opposing sides is longer than the remaining sides.

According to embodiments of the disclosure, a glue tab for pulling dents from vehicle bodies includes a head portion and a dent attachment portion. The head portion is configured to interface with a pulling tool. The dent attachment portion has an elongated planar bottom surface extending along a longitudinal axis. The dent attachment portion further includes a margin configured to flex when the dent attachment portion is affixed to a dent in the vehicle body and a pulling force is applied the head portion by the pulling tool. The dent attachment portion includes an elongated stepped up portion disposed above the bottom surface. The elongated stepped up portion has an axial length that is larger than an axial length of the bottom surface

In embodiments, the dent attachment portion has a generally symmetrical planar bottom surface. In embodiments, the dent attachment portion has an elongated planar bottom surface. In embodiments, the dent attachment portion has an elongated stepped up portion disposed above the bottom surface. In embodiments, a neck portion extends vertically between the stepped up portion and the head portion. In embodiments, one or more arms extends downwardly from the neck portion to the elongated stepped up portion along a longitudinal axis of the elongated stepped up portion. In embodiments, the margin is defined by an offset between an outer edge of the bottom surface and an outer edge of the stepped up portion. The margin has a generally fixed width about the entirety of the dent attachment portion.

A feature and advantage of embodiments is a margin of the portion of the glue tab affixed to a dent flexes when pulled. A feature and advantage of embodiments is the glue tab drives force towards the stem when pulled. A feature and advantage of embodiments is the glue tab uniformly lifts a dent when pulled. A feature and advantage is the flexion of the upper pulling layer of the glue tab prevents a volcano effect from occurring when a dent is lifted. Dents that are not uniformly lifted can have defects, such as raised edges and/or a depressed center, requiring that the partially lifted dent be pounded down and the repair process restarted, wasting time, materials, and effort. A feature and advantage of embodiments is that a layered design of the pulling portion allows a single glue tab.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure. Embodiments of the invention will be described with respect to the figures, in which like reference numerals denote like elements, and in which:

FIG. 1A depicts a perspective front view of a paintless dent repair glue tab according to embodiments.

FIG. 1B depicts a perspective bottom view of the paintless dent repair glue tab of FIG. 1A.

FIG. 1C depicts a top view of the paintless dent repair glue tab of FIG. 1A.

FIG. 1D depicts a bottom view of the paintless dent repair glue tab of FIG. 1A.

FIG. 1E depicts an enlarged side view of the paintless dent repair glue tab of FIG. 1A.

FIG. 1F depicts an enlarged cross sectional view of the paintless dent repair glue tab of FIG. 1A taken along the F-F line.

FIGS. 1G-1I depict various embodiments of paintless dent repair glue tabs with varying widths of stepped up and bottom layers.

FIG. 1J depicts a perspective front view of a paintless dent repair glue tab according to embodiments.

FIG. 1K depicts a side view of the paintless dent repair glue tab of FIG. 1G.

FIG. 1L depicts a bottom view of the paintless dent repair glue tab of FIG. 1G.

FIGS. 1M-1N depict various embodiments of paintless dent repair glue tabs with varying diameters of stepped up layers.

FIG. 2A depicts a perspective front view of a paintless dent repair glue tab according to embodiments.

FIG. 2B depicts an enlarged side view of the paintless dent repair glue tab of FIG. 2A.

FIG. 2C depicts a top view of the paintless dent repair glue tab of FIG. 2A.

FIGS. 2D-2G depict various embodiments of paintless dent repair glue tabs with varying widths of stepped up and bottom layers.

FIG. 2H depicts a perspective front view of a paintless dent repair glue tab according to embodiments.

FIG. 2I depicts a bottom view of the paintless dent repair glue tab of FIG. 2I.

FIG. 2J depicts a perspective front view of a paintless dent repair glue tab according to embodiments.

FIG. 2K depicts a bottom view of the paintless dent repair glue tab of FIG. 2K.

FIG. 3A depicts a perspective view of a paintless dent repair glue tab according to embodiments receiving adhesive.

FIG. 3B depicts a perspective view of the paintless dent repair glue tab of FIG. 3A being affixed to a dent.

FIG. 3C depicts a side view of a paintless dent repair glue tab inserted into a tool, according to embodiments.

FIG. 3D depicts a side view of the paintless dent repair glue tab of FIG. 3C being pulled by the tool.

FIG. 3E depicts a side view of a paintless dent repair glue tab being affixed to a dent, according to embodiments.

FIG. 3F depicts a side view of a paintless dent repair glue tab being affixed to a dent, according to embodiments.

While the embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

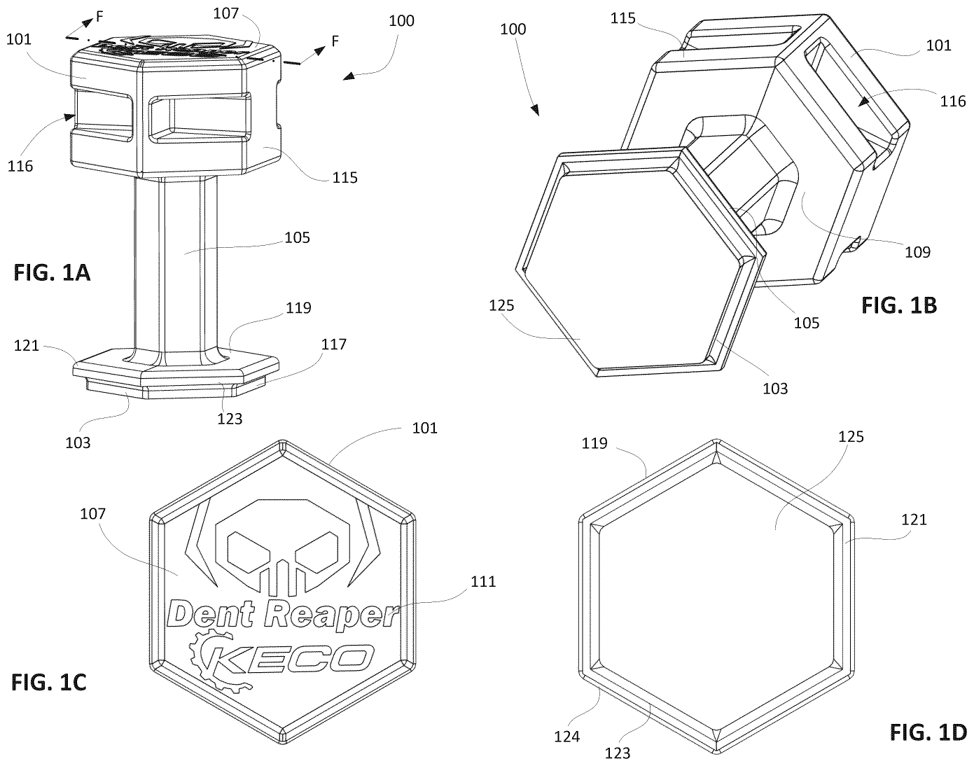

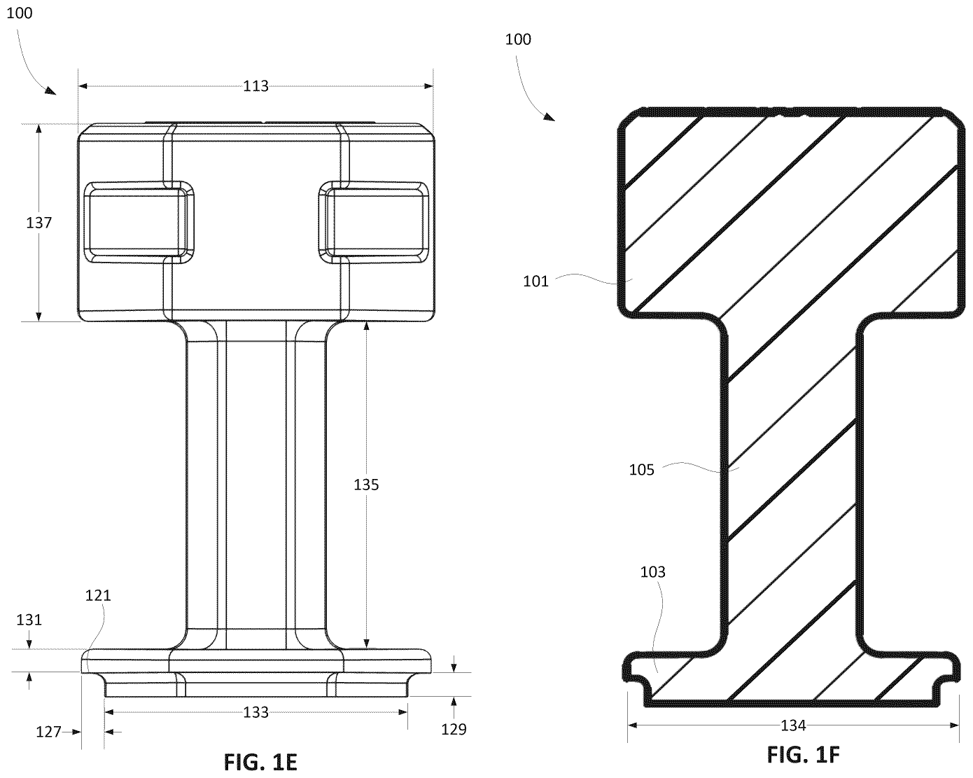

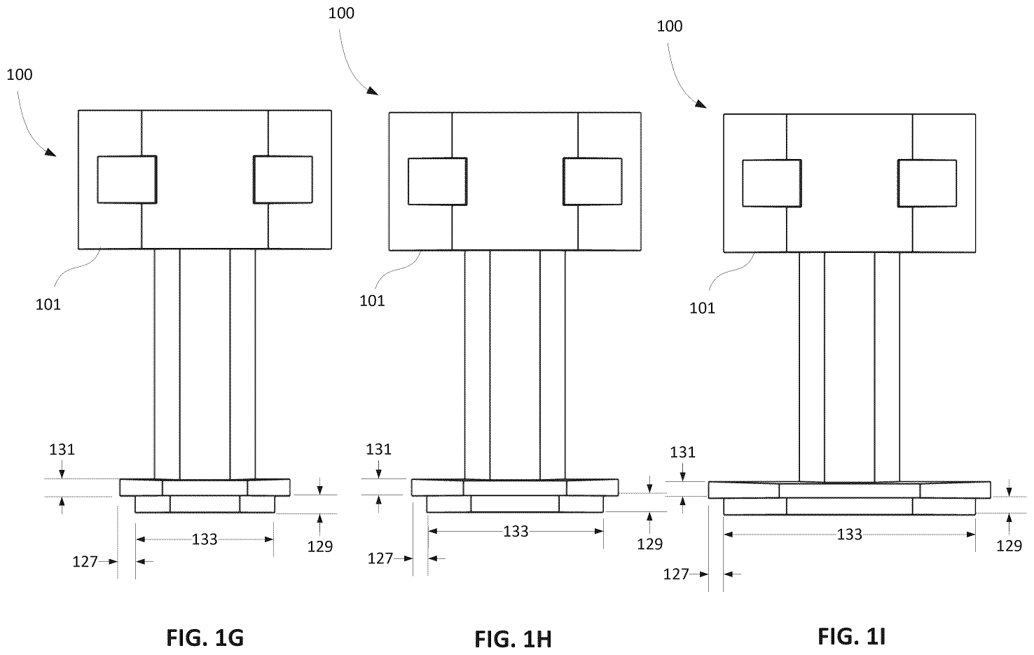

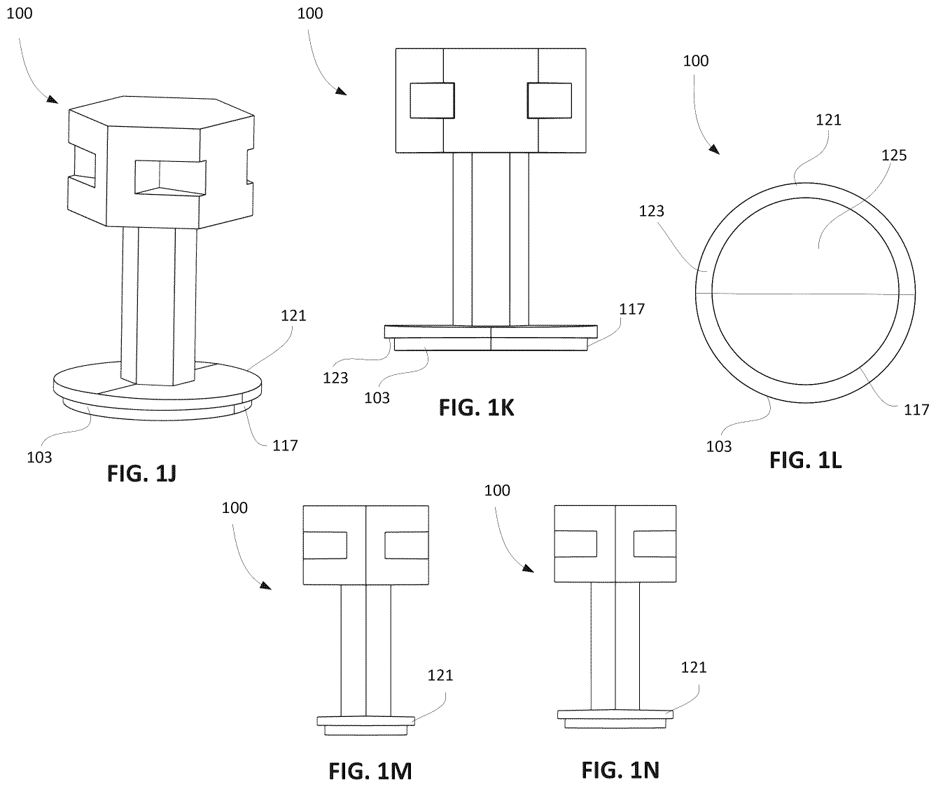

Referring to FIGS. 1A-F, a paintless dent repair glue tab 100 is shown suitable for removing dents from a vehicle body. Glue tab 100 has a head portion 101, a pulling portion 103, and a stem portion 105. Stem portion 105 extends from pulling portion 103 to head portion 101. Head portion 101 includes a top surface 107 opposite bottom surface 109 and one or more sidewalls 115 there between. Top surface 107 may include indicia 111. In embodiments, indicia may be product markings or the like. In embodiments, indicia may be a size indicator allowing a user to easily locate the desired glue tab. In particular, it may be desirable to select a glue tab having a bottom surface that corresponds to a dent. Such correlation may be, for example, similar size and/or shape.

Head portion 101 may be of various sizes and shapes in order to be received by a pulling tool. Such tools are disclosed, for example, in U.S. Pat. No. 7,343,773 and U.S. Patent Publication 20210220889, the contents of which are incorporated herein for all purposes, teachings, and suggestions. In embodiments, head portion 101 may be circular. In embodiments, head portion 101 may be hexagonal. Head portion 101 may have a width 113 that matches a receiving opening in a pulling tool. In embodiments, width 113 is between 8 and 18 mm. In embodiments, width 113 is between 12 and 15 mm. In embodiments, width 113 is about 14 mm. In embodiments, head portion 101 has a height 137 between 5 and 10 mm. In embodiments, height 137 is about 8 mm. In embodiments, sidewalls 115 may define one or more recesses 116 in head portion 101.

Pulling portion 103 includes a bottom pulling layer 117 and a stepped up pulling layer 119. Bottom pulling layer 117 is narrower than stepped up pulling layer 119, and the difference in width between the bottom pulling layer 117 and the stepped up pulling layer 119 defines a margin 121 extending around an outer perimeter of bottom pulling layer 117. The margin 121 is exposed downward facing surface 122 of the stepped up pulling layer 117 between an outside edge 123 and the bottom pulling layer 117 and the outer edge 124 of the stepped up pulling layer 119. Bottom pulling layer 117 has a bottom surface 125 configured to receive an adhesive and be adhered to a dent, as discussed in further detail below. In embodiments, bottom surface 125 is generally planar.

Stepped up layer 119 is generally geometrically similar to bottom pulling layer 117. Accordingly, margin 121 has a generally constant width 127 around the outer edge 123 of the bottom pulling layer 117. In embodiments, margin width 127 is between 0.25 and 3.5 mm. In embodiments, margin width 127 is about 0.33 mm. In embodiments, margin width 127 is about 0.8 mm. In embodiments, margin width 127 is about 0.9 mm. In embodiments a thickness 129 of bottom layer 117 is substantially the same as a thickness 131 of stepped up layer 119. In embodiments, thicknesses 129, 131 are each between 0.2 and 2 mm. In embodiments, thicknesses 129,131 are each about 0.9 mm. In embodiments, thicknesses 129,131 of bottom layer 117 and stepped up layer 119 may be different. In embodiments, thicknesses 129,131 are substantially similar to margin width 127. In embodiments, thicknesses 129,131 are no more than 15% larger or smaller than margin width 127. When the thicknesses are varied, it may affect the flexing of the outside edge of pulling portion 103, as discussed in further detail below. In embodiments, layers 117, 119 may have a variety of geometric shapes such as circular, oval, hexagonal, or the like. Bottom layer has width 133. In various embodiments of the glue tab, width 133 may differ such that a user has a choice of glue tabs suited to repairing different sized or shaped dents. While the width 133 of bottom layer varies, it should be noted the dimensions of head portion 101 generally do not change. Maintaining consistency of the head portion dimensions, among various embodiments of glue tabs having varying sized pulling portions, allows a single pulling tool to be operable with the various embodiments of glue tabs. In embodiments, width 133 is between 6 and 20 mm. In embodiments, width 133 is about 7.38, 9.38, 11.38, 13.38, or 15.38 mm. In embodiments, a width 134 of the stepped up layer 119 is 9, 11, 13, or 15 mm. FIGS. 1G-1I show glue tabs 100 having varying widths of the layers 117, 119. Note that in the embodiments shown, while the width 133 of the bottom layer and the width 134 of the stepped up layer change, all other dimensions remain fixed. Accordingly, for example, since the dimensions of head portion 101 are unchanged, all embodiments of the glue tab 100 may be interchangeably used with the same dent pulling tool.

Glue tabs according to embodiments may be injection molded, blow molded, or made using similar techniques. In the embodiment depicted in the cross-sectional view of FIG. 1F, the glue tab 100 may be a unitary piece formed from of the same material. In embodiments, glue tabs may be made of plastic. In embodiments, glue tabs may be polycarbonate, polyethylene, polypropylene or the like. In embodiments, the head portion is generally very rigid and adapted for receiving a pulling force from a pulling tool without breakage. In embodiments, the neck and pulling portion may be made of the same or similar materials as the head portion. In embodiments, the pulling portion be more flexible than the head portion. Some degree of flexing in the pulling portion when pulling out a dent may be desirable to more uniformly remove the dent. Glue tabs formed from metal, wooden materials, engineered materials, or other like materials as known in the art are not beyond the scope of this disclosure. In embodiments, glue tabs may be formed from combinations of materials. For example, the pulling portion may be plastic while the head portion is metal.

As dents may be formed in a variety of shapes and sizes, it is useful to have a pulling portion in different shapes and sizes. FIGS. 1J-1L illustrate a glue tab 100 having a circular pulling portion 103. In embodiments, pulling portion 103 may be hexagonal, oval, rectangular, or the like. Pulling portion 103 includes a bottom layer 117 with a bottom surface 125 configured to be adhered to a vehicle body. Stepped up layer 121 is sandwiched between bottom layer 117 and neck 105. Stepped up layer 121 is geometrically similar to and extends beyond bottom layer 117, such that margin 123 extends around a perimeter of bottom layer 117. In embodiments, a width of the stepped up layer 121 is 9, 11, 13, or 15 mm. FIGS. 1M and 1N depict embodiments of glue tabs with different diameters of stepped up layer 121.

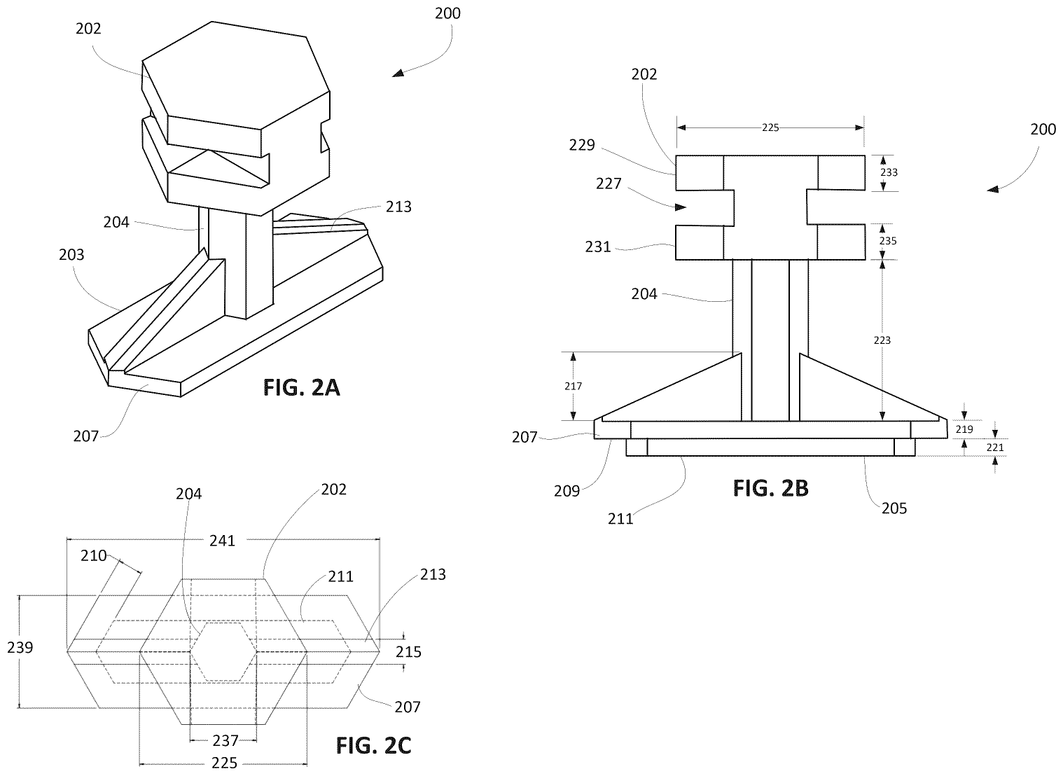

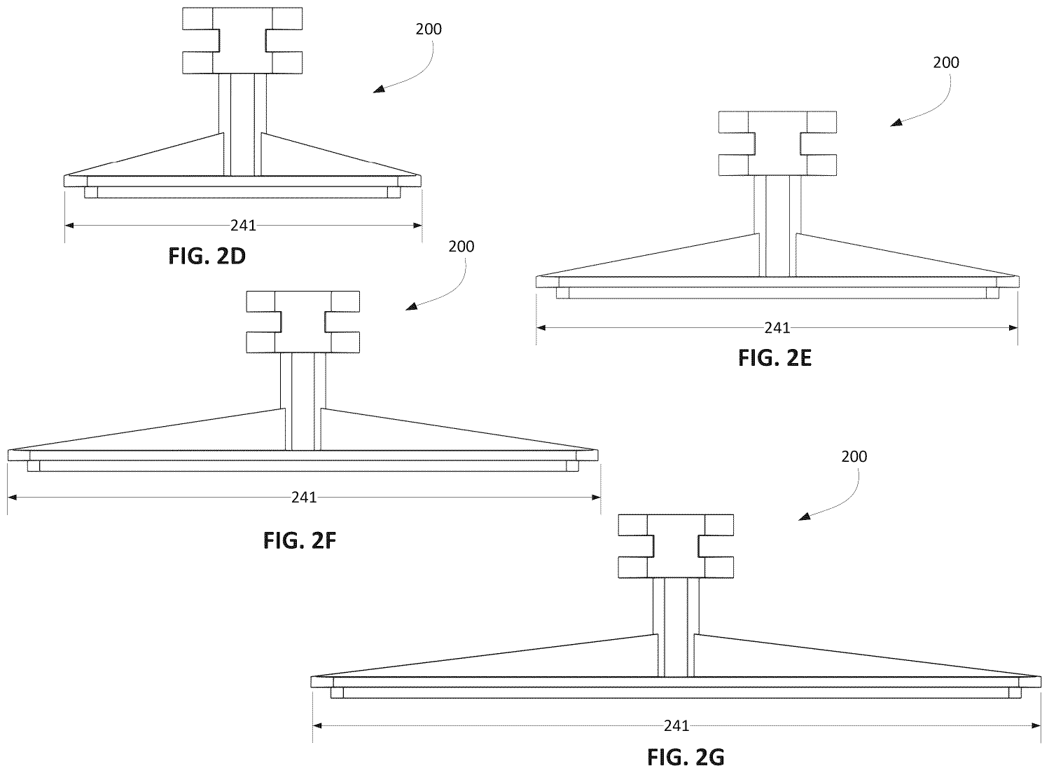

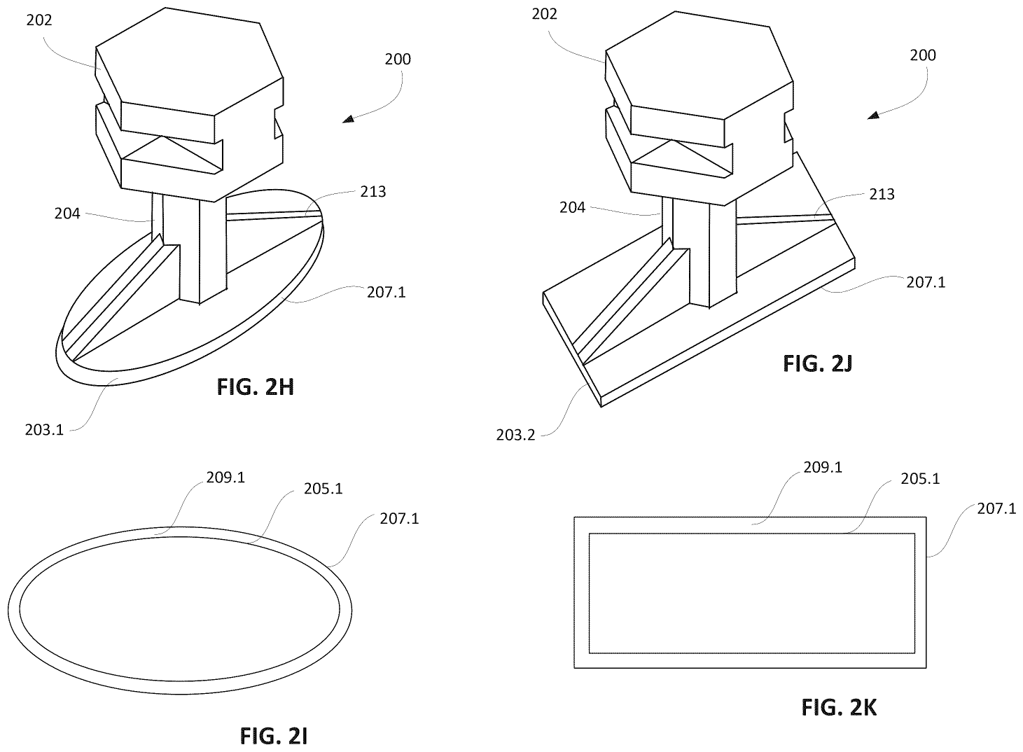

FIGS. 2A-C illustrate a glue tab 200 having an elongated pulling portion 203. FIGS. 2H-2I illustrate a glue tab 200 having an oval pulling portion 203.1. FIGS. 2J-2K illustrate a glue tab 200 having a rectangular pulling portion 203.2. Referring specifically to FIG. 2I, a bottom view of an oval pulling portion 203.1 is shown with stepped up layer 207.1 being wider than bottom layer 205.1 and defining margin 209.1 therebetween. Referring specifically to FIG. 2K, a bottom view of a rectangular pulling portion 203.2 is shown with stepped up layer 207.2 being wider than bottom layer 205.2 and defining margin 209.2 therebetween. In embodiments, elongated pulling portion 203 may be circular, hexagonal, oval, rectangular, or the like. Pulling portion 203 includes a bottom layer 205 with a bottom surface 211 configured to be adhered to a dent, such as a dent on a vehicle body. Stepped up layer 207 is sandwiched between bottom layer 205 and neck 204. Head portion 202 may be affixed to neck 204 at a top portion, opposite to stepped up layer 207. Stepped up layer 207 is geometrically similar to and wider than bottom layer 203, such that margin 209 extends around a perimeter of bottom layer 205. In embodiments, margin 209 has a width 210 between 1 and 5 mm. In embodiments, margin 209 is about 2 mm. Some elongated shapes of pulling portion 203 may lead to structural instability or breakage when glue tab 200 is pulled. Accordingly, embodiments of the invention may include one or more arms 213 extending from neck 105 and along the central axis of stepped up layer 207. In embodiments, arm 213 may be generally triangular shaped. In embodiments, arm 213 may taper downwardly from neck 105 to an outer edge of stepped up layer 207. In some embodiments, arm 213 may have a width 215 of between 1 and 3 mm. In some embodiments, arm 213 may have a width of about 2 mm. In some embodiments, arm 213 may have a height 217 between 2 and 10 mm. In some embodiments, arm 213 may have a height 217 of about 4.8 mm. In some embodiments, stepped up layer 207 has a height 219 between 0.5 and 3 mm. In some embodiments, stepped up layer 207 has a height 219 of about 1.25 mm. In some embodiments, bottom layer 205 has a height 221 between 0.5 and 3 mm. In some embodiments, bottom layer has a height 221 of about 1.25 mm. In some embodiments the height 219 of the stepped up layer 207 is substantially similar to the height 221 of the bottom layer 205. In embodiments, stem portion 105 has a height 223 between 8 and 15 mm. In embodiments, stem portion 105 has a height of about 11.5 mm. In embodiments, head portion 202 has a width 225 between 10 and 20 mm. In embodiments, head portion 202 has a width 225 of about 13.4 mm. Head portion 202 may have one or more recesses 227 dividing head portion 202 into an upper portion 229 and a lower portion 231. In embodiments, upper portion 229 has a height 233 between 1.5 and 3.5 mm. In embodiments, upper portion 229 has a height 233 of about 2.45 mm. In embodiments, lower portion 231 has a height 235 between 1.5 and 3.5 mm. In embodiments, lower portion 231 has a height 235 of about 2.45 mm. In embodiments, upper and lower portions 229, 231 have similar heights. In embodiments, a height of the recess 227 is similar to the height of both the upper and lower portions 229, 231. In embodiments, neck 204 has a width 237 between 4 and 8 mm. In embodiments, neck 204 has a width 237 of about 5.33 mm. In embodiments, stepped up layer 207 has a width 239 between 5 and 15 mm. In embodiments, stepped up layer 207 has a width 239 of about 9 mm. In embodiments, stepped up layer 207 has a length 241 between 15 and 100 mm. In embodiments, stepped up layer 207 has a length 241 of 25, 40, 55, 70, or 85 mm. FIGS. 2D-2G illustrate embodiments of a glue tab 200 having various lengths of 241 of the stepped up layer 207.

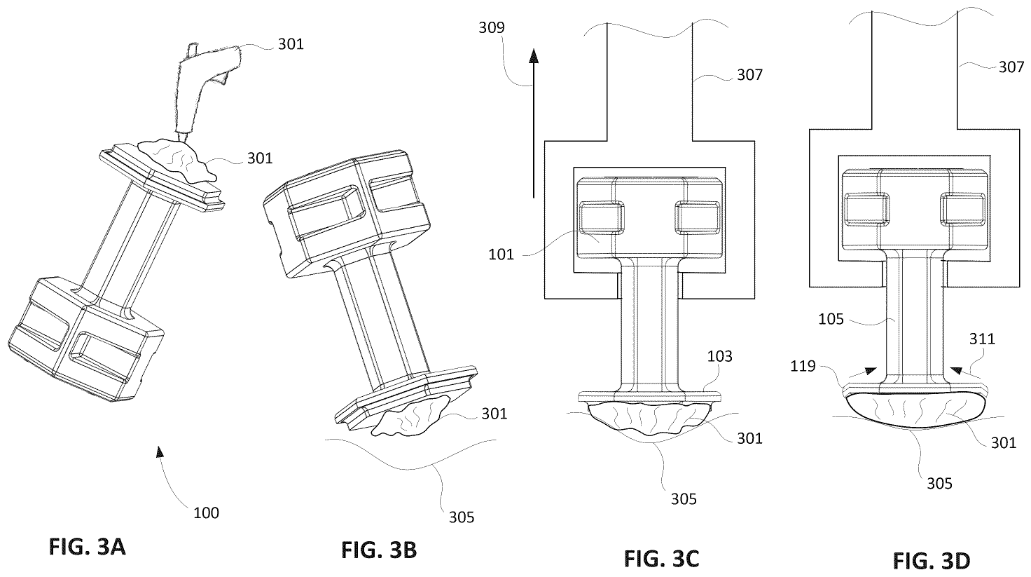

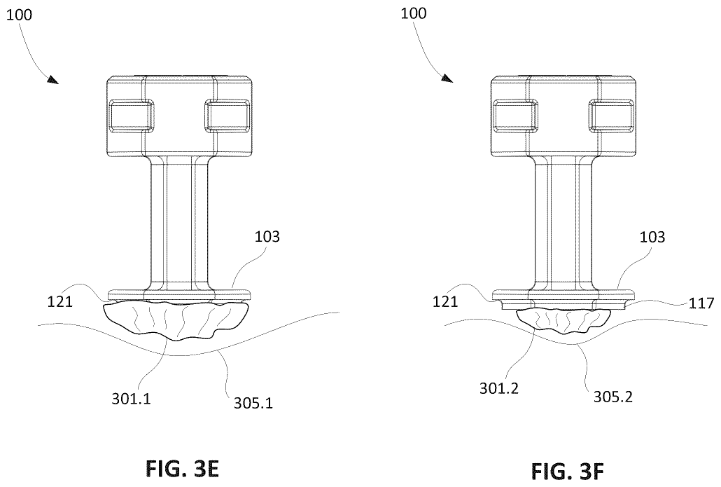

Referring to FIGS. 3A-3D, a method of removing a dent with a glue tab according to embodiments of the invention is illustrated. An adhesive, such as glue 301, is administered to the bottom surface 125 of glue tab 100. Glue 301 may be administered using a glue gun 303 or other means known in the art. Adhesive 301 is then positioned over a dent 305, and the glue tab 100 is pressed into place such that the adhesive 301 bonds the dent 305 to glue tab 100. Pulling tool 307 is secured about head portion 101, and a pulling tool 307 is pulled in an upward direction away from dent 305. When the glue tab is pulled, pulling force 311 is exerted along an edge of the pulling portion 103 and towards neck 105. Pulling portion 103 will flex about margin 121, causing the stepped up pulling layer 119 of the pulling portion 103 to cup. This results in a more uniform pull across the dent, with a longer pull on the deeper portions of the dent and less about the edges. Accordingly, the dent will pop out in a uniform manner, and not leave behind aberrations, such as a volcano shape with a depressed center, which requires laboriously pounding out the aberrations and restarting the dent repair process. Once the dent is pulled out, the adhesive may be dissolved, such as with alcohol, so that the glue tab may be removed without any damage to paint or the body surface.

Referring to FIGS. 3E and 3F, a glue tab 100 is depicted being affixed to dents of various sizes 305.1, 305.2 using differing amounts of adhesive 301.1, 301.2. Referring specifically to FIG. 3E, glue tab 100 is shown being used to pull a large dent 301.1. Accordingly, a large amount of adhesive 301.1 is applied to the glue tab 100 which overflows margin 121 and fully engages the stepped up pulling layer 119 of the pulling portion 103. As described above, engaging the stepped up layer 119 provides an improved pull. However, applying a smaller amount of adhesive 301.2, as shown in FIG. 3F, allows the glue tab 100 to better conform to smaller dent 305.2 by engaging only the bottom pulling layer 117. Accordingly, by varying only the amount of adhesive applied, a single size of glue tab may be used to pull various sized dents.

The following U.S. patents and U.S. patent publications contain content, aspects, structure, components, and functionalities relating to or applicable to paintless dent repair devices, kits, and methods of use, and are incorporated by reference herein in their entireties for all purposes: U.S. Pat. Nos. 3,765,220; 9,889,483; and US20210060633.

Although the present invention has been described with reference to particular embodiments, those skilled in the art will recognize that changes may be made in form and substance without departing from the spirit and scope of the invention. The embodiments described above are intended to be illustrative and not limiting.

What is claimed is:

1. A glue tab for paintless dent repair comprising:
a head portion; a dent lifting portion; a stem there between; and
wherein the dent lifting portion comprises an affixment portion having a flat bottom surface configured to be affixed to a dent in a vehicle body and a first perimeter extending along an outer edge of the flat bottom surface; and
a stepped up portion between the stem and the affixment portion, the stepped up portion having a second perimeter that substantially follows the first perimeter, wherein the stepped up portion is wider than the affixment portion, and
wherein the glue tab is a single polymer piece.

2. The glue tab of claim 1, wherein the affixment portion has a first thickness and the stepped up portion has a second thickness, the first and second thicknesses being substantially similar.

3. The glue tab of claim 1, wherein a difference in width between the first and second perimeters remains constant around an entirety of the perimeters of the affixment portion and the stepped up portion.

4. The glue tab of claim 3, wherein the difference in width is between 0.25 and 3.5 mm.

5. The glue tab of claim 3, wherein the difference in width is about 0.9 mm.

6. The glue tab of claim 1, wherein a planar cross section of the affixment portion is geometrically similar to a planar cross section of the stepped up portion.

7. The glue tab of claim 1, wherein the head portion is configured to interface with a pulling tool.

8. The glue tab of claim 1, wherein the head portion comprises a hexagonal top surface.

9. The glue tab of claim 1, wherein a first end of the stem is generally centered on the stepped up portion and an opposite end of the stem is generally centered on the head portion.

10. A device for removing dents from a vehicle body comprising:
a first lifting surface configured for attachment to the vehicle body;
a second lifting surface disposed on top of the first lifting surface, the second lifting surface having a margin portion extending outwardly beyond an outside edge of the first lifting surface, the margin portion being defined by the outside edge of the first lifting surface and an outside edge of the second lifting surface such that the outside edge of the second lifting surface can flex about the first lifting surface; and
a gripping portion affixed to the second lifting surface.

11. The device of claim 10, wherein the margin portion has a constant width.

12. The device of claim 11, wherein the constant width is within 10% of a thickness of the first lifting surface.

13. The device of claim 12, wherein a thickness of the second lifting surface is the same as the thickness of the first lifting surface.

14. The device of claim 10, wherein a neck extends between the second lifting surface and the gripping portion, and wherein the neck is narrower than the second lifting surface.

15. The device of claim 10, wherein the first and second lifting surfaces define a circular shape.

16. The device of claim 10, wherein the first and second lifting surface defines a shape with four or more sides, wherein a pair of opposing sides is longer than the remaining sides.

17. A glue tab for pulling dents from vehicle bodies comprising:
a head portion configured to interface with a pulling tool; and
a dent attachment portion having an elongated planar bottom surface extending along a longitudinal axis and a margin configured to flex when the dent attachment portion is affixed to a dent in the vehicle body and a pulling force is applied the head portion by the pulling tool, wherein the dent attachment portion comprises an elongated stepped up portion disposed above the bottom surface, the elongated stepped up portion having an axial length that is larger than an axial length of the bottom surface;
a neck portion extending vertically between the stepped up portion and the head portion; and
an arm extending downwardly from the neck portion to the elongated stepped up portion along the longitudinal axis.

18. The glue tab of claim 17, wherein the dent attachment portion has a generally symmetrical planar bottom surface.

19. The glue tab of claim 17, wherein the dent attachment portion has an elongated planar bottom surface.

20. The glue tab of claim 17, wherein the margin is defined by an offset between an outer edge of the bottom surface and an outer edge of the stepped up portion, the margin having a generally fixed width about the entirety of the dent attachment portion.
